(19) United States
(12) Patent Application Publication
(10) Pub. No.: US 2020/0119675 A1
(43) Pub. Date: Apr. 16, 2020

(54) MOTOR CONTROL DEVICE AND SHEET CONVEYANCE APPARATUS

(71) Applicant: CANON KABUSHIKI KAISHA, Tokyo (JP)

(72) Inventors: Yuya Tanaka, Yashio-shi (JP); Junichi Suwa, Kashiwa-shi (JP); Yushi Oka, Abiko-shi (JP)

(21) Appl. No.: 16/598,954

(22) Filed: Oct. 10, 2019

(30) Foreign Application Priority Data
Oct. 16, 2018 (JP) 2018-195389
Jul. 17, 2019 (JP) 2019-132262

(51) Int. Cl. H02P 21/18; H02P 21/22; G03G 15/00; B65H 7/20; B65H 7/06

(52) U.S. Cl. CPC H02P 21/18; H02P 21/22; B65H 7/06; B65H 7/20; G03G 15/6529

(57) ABSTRACT

A motor control device include a detector that detects a drive current flowing through a winding of a motor, a first determiner that determines a rotation phase of a rotor of the motor, using preset control values, a controller that controls the drive current to reduce a deflection between the rotation phase determined by the first determiner and an instructed phase representing a target phase of the rotor, a first discriminator that determines whether rotation of the motor is abnormal, and a second discriminator that identifies a type of a motor attached to the motor control device.

If the first discriminator determines that the rotation of the motor attached to the motor control device is abnormal, the controller sets a control value corresponding to the type of the motor identified by the second discriminator, as the control value that the first determiner uses when determining the rotation phase.

### BACKGROUND

### Field of the Disclosure

The present disclosure relates to motor control performed by a motor control device and a sheet conveyance apparatus.

### Description of the Related Art

Vector control is known as a conventional method of controlling a motor. According to vector control, a motor is controlled by controlling a current value defined in a rotary coordinate system with reference to a rotation phase of a rotor of the motor. Specifically, this control method is known as a method of controlling a motor through phase feedback control by which a current value defined in a rotary coordinate system is controlled in such a way as to reduce a deflection between an instructed phase of a rotor and a rotation phase of the same. Another control method is also known as a method of controlling a motor through speed feedback control by which a current value defined in a rotary coordinate system is controlled in such a way as to reduce a deflection between an instructed speed of a rotor and a rotating speed of the same.

In vector control, a drive current flowing through a winding of a motor is expressed in terms of a q-axis component (torque current component), which is a current component that causes the rotor to generate a torque for its rotation, and a d-axis component (exciting current component), which is a current component that affects the intensity of magnetic flux penetrating the winding of the motor. A value for the torque current component is controlled in accordance with a change in a load torque applied to the rotor. As a result, a torque needed for rotation of the rotor is generated efficiently. This suppresses an increase in motor noise and power consumption that are caused by surplus torque.

In vector control, a configuration for determining a rotation phase of the rotor is required. U.S. Pat. No. 8,970,146 describes a configuration in which an induced voltage generated at a winding through the rotation of a rotor is determined, using values characteristic of a motor (which will hereinafter be referred to as “control value”), such as the resistance R and inductance L of the winding, and based on the induced voltage, a rotation phase of the rotor is determined.

The control values that are used to determine the induced voltage according to the method described in U.S. Pat. No. 8,970,146 are values characteristic of the motor, and are preset based on values for the resistance R and inductance L of the winding of the motor to be attached to a motor control device.

For example, if a motor B different in type from a motor A is attached to a motor control device in which control values corresponding the motor A are set and vector control is executed in such a condition, a rotation phase of a rotor of the motor B cannot be determined highly precisely. As a result, control of the motor B becomes unstable, leading to a possibility of the motor B stepping out.

Even if running the motor B through vector control is resumed after the motor B steps out, the motor B may step out again because control values set in the motor control device are the control values corresponding to the motor A. In this manner, if the motor B is attached to the motor control device in which the control values corresponding to the motor A are set, it may lead to repeated step-out of the motor B because the control values not corresponding to the motor B are set in the motor control device.

### SUMMARY

The present disclosure has been conceived in view of the above problems, and an aspect of the present disclosure is to inhibit recurrences of abnormal rotation of a motor.

In order to solve the above problems, a motor control device according to the present disclosure is a motor control device, including: a detector configured to detect a drive current flowing through a winding of a motor attached to the motor control device; a first determiner configured to determine a rotation phase of a rotor of the motor attached to the motor control device, using the drive current detected by the detector and a preset control value; a controller configured to control the drive current flowing through the winding of the motor attached to the motor control device in such a way as to reduce a deflection between the rotation phase determined by the first determiner and an instructed phase representing a target phase of the rotor of the motor; a first discriminator configured to determine whether rotation of the motor attached to the motor control device is abnormal; and a second discriminator configured to identify, in a case where the first discriminator determines that the rotation of the motor attached to the motor control device is abnormal, a type of the motor attached to the motor control device, wherein in a case where the first discriminator determines that the rotation of the motor attached to the motor control device is abnormal, the controller sets a control value corresponding to the type of the motor identified by the second discriminator, as the control value that the first determiner uses when determining the rotation phase.

Further features of the present disclosure will become apparent from the following description of exemplary embodiments (with reference to the attached drawings).

### BRIEF DESCRIPTION OF THE DRAWINGS

FIG. 1 is a sectional view for explaining an image forming apparatus according to a first embodiment.

FIG. 2 is a block diagram showing a control configuration of the image forming apparatus according to the first embodiment.

FIG. 3 is a diagram showing a relationship between a motor operating at two phases, i.e., an A phase and a B phase and a rotary coordinate system expressed with a d-axis and a q-axis.

FIG. 4 is a block diagram showing a configuration of a motor control device according to the first embodiment.

FIGS. 5A and 5B each show a deflection Δθ between an instructed phase θ_ref and a rotation phase θ.

FIG. 6 is a chart for explaining a method of identifying a type of a motor.

FIG. 7 is a flowchart for explaining a motor type identifying method according to the first embodiment.

FIGS. 8A and 8B each show an example of a change in a temperature T of the motor.

FIG. 9 is a flowchart for explaining a motor type identifying method according to a second embodiment.

FIG. 10 is a chart showing a relationship between the temperature T of the motor and a sum of current values iq.

FIG. 11 is a sectional view for explaining an image forming apparatus according to a fifth embodiment.

FIG. 12 is a flowchart for explaining a motor type identifying method according to the fifth embodiment.

FIG. 13 is a block diagram showing a configuration of a motor control device that performs speed feedback control.

### DESCRIPTION OF THE EMBODIMENTS

Preferred embodiments of the present disclosure will hereinafter be described with reference to the drawings. It should be noted that the shapes, relative arrangement, and the like of components described in the embodiments should be changed properly depending on a configuration of a device or apparatus to which the present disclosure is applied or various conditions under which the device or apparatus operates, and that the scope of the disclosure is not limited by the embodiments that will be described below. In the following description, a case where a motor control device is incorporated in an image forming apparatus will be explained. The motor control device, however, may be incorporated in an apparatus other than the image forming apparatus. For example, the motor control device may be incorporated also in a sheet conveyance apparatus that conveys sheets of recording mediums, documents, or the like.

[Image Forming Apparatus]

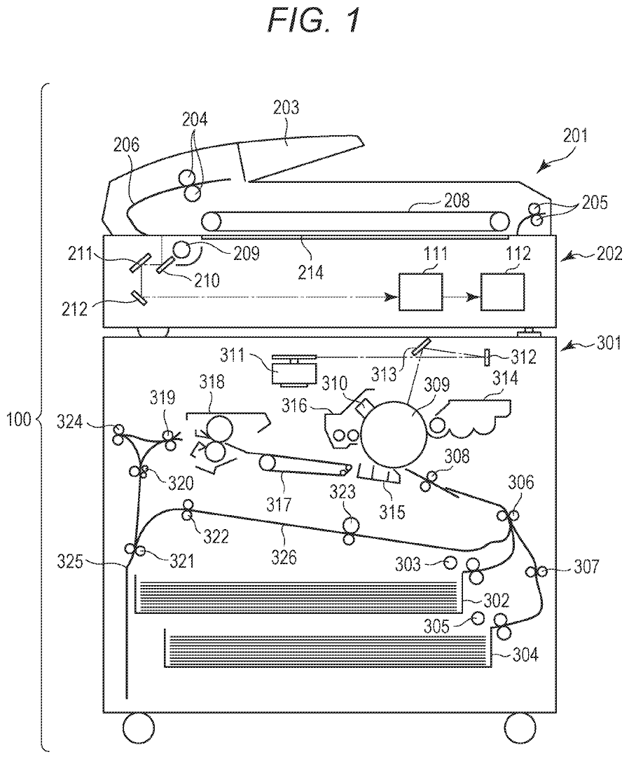

FIG. 1 is a sectional view showing a configuration of a copier (hereinafter, “image forming apparatus”) 100 including a sheet conveyance apparatus used in a first embodiment, the copier 100 adopting a black-and-white electrophotographic method. The image forming apparatus is provided not only as a copier but also as a fax machine, a printer, and the like. A recording method adopted by the image forming apparatus is not limited to the black-and-white electrophotographic method. The image forming apparatus may adopt, for example, an ink jet method. The image forming apparatus produces either black-and-white images or colored one.

A configuration and functions of the image forming apparatus 100 will hereinafter be described with reference to FIG. 1. As shown in FIG. 1, the image forming apparatus 100 includes a document feeder 201, a reading device 202, and an image printer 301.

A document stacked on a document stacking unit 203 of the document feeder 201 is sent forward by feed rollers 204 and is conveyed along a conveyance guide 206 to a document-bearing glass board 214 of the reading device 202. The document is then transferred further by a conveyance belt 208 and is discharged by discharging rollers 205 onto a discharging tray (not depicted). At a reading position on the reading device 202, the document is exposed to light from a lighting system 209, which causes reflection light to come out of an image carried by the document. This reflection light is guided by an optical system composed of reflective mirrors 210, 211, and 212 to travel to an image reader 111, which turns the reflection light into an image signal. The image reader 111 is made up mainly of a lens, a charge-coupled device (CCD), which is a photoelectric conversion element, and a drive circuit for driving the CCD. The image signal is then output from the image reader 111 to an image processor 112 including of a hardware device, such as an application-specific IC (ASIC). The image processor 112 carries out various correction processes on the image signal and then sends it to the image printer 301. Through the above process, the image is read from the document. In other words, the document feeder 201 and the reading device 202 jointly function as a document reading device.

document reading mode includes a first reading mode and a second reading mode. The first reading mode is a mode in which an image carried by a document conveyed at constant speed is read by the lighting system 209 and optical system that are fixed at a given position. The second reading mode is a mode in which an image carried by a document placed on the document-bearing glass board 214 of the reading device 202 is read by the lighting system 209 and optical system that move at constant speed. Usually, an image carried by a sheet of document is read in the first reading mode, while an image carried by a document of a book or booklet in a bound form is read in the second reading mode.

The image printer 301 has sheet storage trays 302 and 304 placed therein. In the sheet storage tray 302 and the sheet storage tray 304, two types of recording media can be stored respectively. For example, A4 sheets with a standard thickness are stored in the sheet storage tray 302, while A4 sheets with a large thickness are stored in the sheet storage tray 304. A recording medium refers to a medium on which an image is formed by the image forming apparatus. For example, a document, a resin sheet, a cloth, an overhead projector (OHP) sheet, and a label are all regarded as recording media.

A recording medium stored in the sheet storage tray 302 is picked up by a pickup roller 303 and is conveyed by conveyance rollers 306 to registration rollers 308. Meanwhile, a recording medium stored in the sheet storage tray 304 is picked up by a pickup roller 305 and is conveyed by transfer rollers 307 and 306 to the registration rollers 308.

An image signal coming out of the reading device 202 is input to an optical scanner 311 including a semiconductor laser and a polygon mirror. A photosensitive drum 309 has its peripheral surface electrified by an electrifier 310. Following electrification of the peripheral surface of the photosensitive drum 309, a laser beam corresponding to the image signal input from the reading device 202 to the optical scanner 311 is emitted from the optical scanner 311 and travels to the polygon mirror, a mirror 312, and a mirror 313 in sequence to fall onto the peripheral surface of the photosensitive drum 309. As a result, a static latent image is formed on the peripheral surface of the photosensitive drum 309.

Subsequently, the static latent image is developed by toner in a developer 314, forming a toner image on the peripheral surface of the photosensitive drum 309. The toner image formed on the photosensitive drum 309 is then transferred to a recording medium by a transfer electrifier 315 disposed in a location (transfer location) counter to the photosensitive drum 309. The registration rollers 308 send a recording medium to the transfer location at a right point of time at which the toner image is transferred.

The recording medium carrying the toner image transferred thereto through the above process is conveyed by a conveyance belt 317 to a fixing unit 318, which applies heat and pressure to the toner image to fix it to the recording medium. Through these processes, the image forming apparatus 100 forms an image on the recording medium.

When image formation is carried out in a single-side printing mode, the recording medium having passed through the fixing unit 318 is discharged by discharging rollers 319 and 324 onto a discharging tray (not depicted). When image formation is carried out in a double-side printing mode, on the other hand, after the toner image is fixed by the fixing unit 318 to a first surface of the recording medium, the recording medium is sent by the discharging rollers 319, conveyance rollers 320, and reverse rollers 321 to a reverse path 325. The recording medium is then sent by conveyance rollers 322 and 323 back to the registration rollers 308, after which an image is formed on a second surface of the recording medium by the method described above. Afterward, the recording medium is discharged by the discharging rollers 319 and 324 onto the discharging tray (not depicted).

When the recording medium carrying an image formed on its first surface is to be discharged facedown out of the image forming apparatus 100, the recording medium having passed through the fixing unit 318 is conveyed in a direction in which the recording medium travels through the discharging rollers 319 to head toward the conveyance rollers 320. Subsequently, right before the rear end of the recording medium passes through a nipping portion of the conveyance rollers 320, the conveyance rollers 320 reverse their rotation, thus turning the recording medium over. As a result, the recording medium with its first surface facing downward travels through the discharging rollers 324 and is discharged out of the image forming apparatus 100.

What is described above provides the detail of the configuration and functions of the image forming apparatus 100. A load mentioned in this embodiment refers to an object driven by a motor. For example, various rollers (including conveyance rollers), such as the feed rollers 204, the pickup rollers 303 and 305, the registration rollers 308, and the discharging rollers 319, are equivalent to loads in this embodiment. Likewise, the photosensitive drum 309 and the developer 314 are also equivalent to loads in this embodiment. The motor control device according to this embodiment can be applied to a motor that drives such loads.

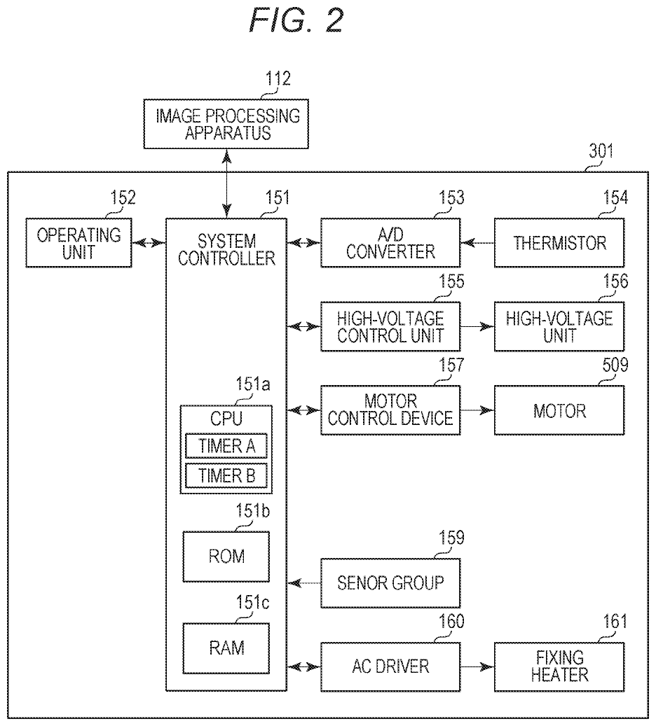

FIG. 2 is a block diagram showing an example of a control configuration of the image forming apparatus 100. As shown in FIG. 2, a system controller 151 has a CPU 151a, a ROM 151b, and a RAM 151c. The system controller 151 is connected to an image processor 112, an operating unit 152, an analog/digital (A/D) converter 153, a high-voltage control unit 155, a motor control device 157, a sensor group 159, and an AC driver 160. The system controller 151 is capable of transmitting/receiving data and commands to/from units connected to the system controller 151.

The CPU 151a reads various programs out of the ROM 151b and executes them to carry out various sequences related to a predetermined image formation sequence.

The RAM 151c is a memory device. The RAM 151c stores various data therein, the data including a set value for the high-voltage control unit 155, an instructed value for the motor control device 157, and information from the operating unit 152.

The system controller 151 transmits set value data on various units and devices incorporated in the image forming apparatus 100, the data being necessary for image processing by the image processor 112, to the image processor 112. The system controller 151 receives a signal from the sensor group 159 and sets a set value for the high-voltage control unit 155, based on the received signal.

In accordance with the set value set by the system controller 151, the high-voltage control unit 155 supplies a necessary voltage to a high-voltage unit 156 (which is the electrifier 310, the developer 314, the transfer electrifier 315, or the like).

The motor control device 157 controls a motor 509 in accordance with an instruction output from the CPU 151a. FIG. 2 indicates only the motor 509 as a motor included in the image forming apparatus. Actually, however, the image forming apparatus includes two or more motors. One motor control device may control a plurality of motors. FIG. 2 indicates one motor control device only. However, the image forming apparatus may include two or more motor control devices.

The A/D converter 153 receives a detection signal indicative of a temperature detected by a thermistor 154 that detects the temperature of a fixing heater 161, converts the detection signal in the form of an analog signal into a digital signal, and transmits the digital signal to the system controller 151. Based on the incoming digital signal from the A/D converter 153, the system controller 151 controls the AC driver 160. The AC driver 160 controls the fixing heater 161 to adjust the temperature of the fixing heater 161 to a temperature required for a fixing process. The fixing heater 161 is a heater used to carry out the fixing process, and is included in the fixing unit 318.

The system controller 151 controls the operating unit 152 to cause it to put an operation screen on a display fitted to the operating unit 152, the operation screen being used by the user to make settings including setting on a type of a recording medium to be used (hereinafter, “sheet type”). The system controller 151 receives information set by the user, from the operating unit 152, and controls an operation sequence of the image forming apparatus 100, based on the information set by the user. The system controller 151 transmits information indicative of a state of the image forming apparatus, to the operating unit 152. Information indicative of a state of the image forming apparatus includes, for example, information on the number of sheets carrying images formed thereon, on a status of progress of an image forming process, and on sheet jamming or redundant sheet feeding in the document reading device 201 and the image printer 301. The operating unit 152 displays the incoming information from the system controller 151 on the display.

In the above described manner, the system controller 151 controls the operation sequence of the image forming apparatus 100.

[Motor Control Device]

The motor control device 157 according to this embodiment will then be described. The motor control device 157 according to this embodiment controls the motor 509 through vector control. According to this embodiment, a motor A or a motor B different in type from the motor A is incorporated as the motor 509, into the image forming apparatus 100. In the following description, a configuration in which the motor A is incorporated as the motor 509, into the image forming apparatus 100 will be explained.

<Vector Control>

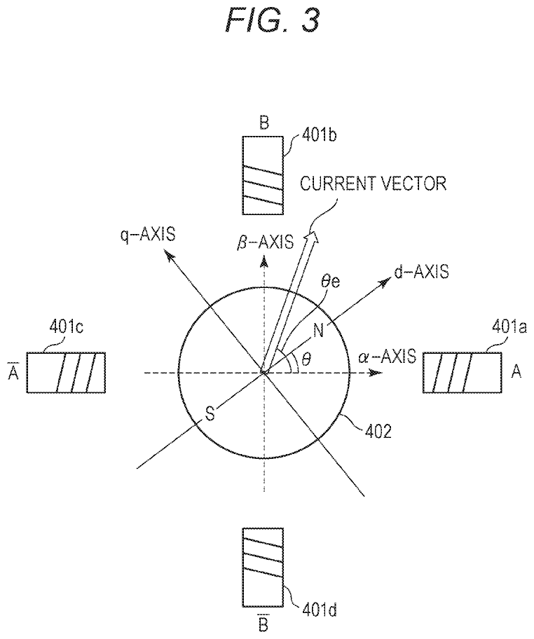

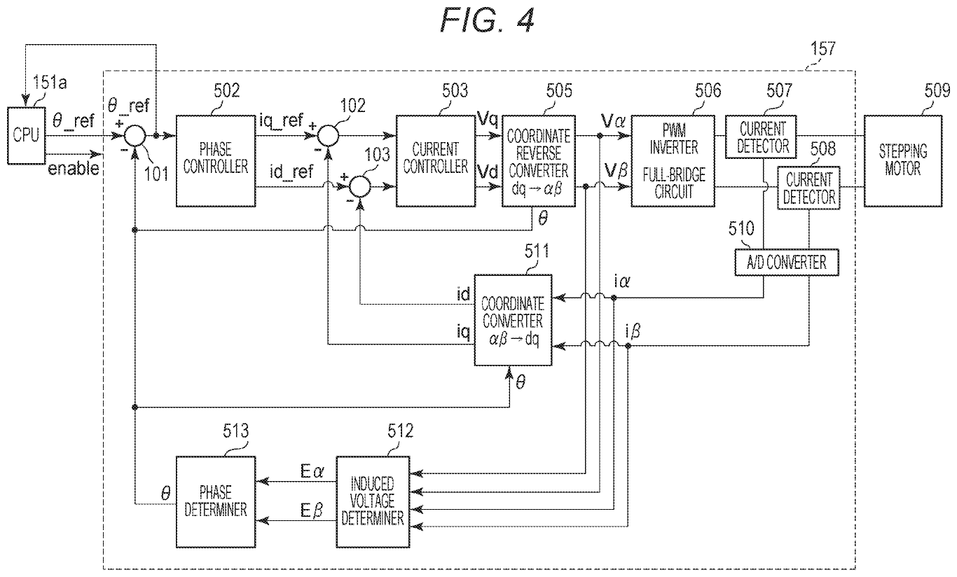

A method by which the motor control device 157 according to this embodiment carries out vector control will first be described with reference to FIGS. 3 and 4. The motor that will be mentioned in the following description is not provided with a sensor, such as a rotary encoder for detecting a rotation phase of a rotor of the motor.

FIG. 3 is a diagram showing a relationship between a stepping motor (hereinafter “motor”) 509 operating at two phases, i.e., an A phase (first phase) and a B phase (second phase) and a rotary coordinate system expressed with a d-axis and a q-axis. In FIG. 3, an α-axis corresponding to a winding of the A phase and a β-axis corresponding to a winding of the B phase are defined in a stationary coordinate system. In FIG. 3, the d-axis is defined along the direction of magnetic flux created by the magnetic poles of a permanent magnet making up a rotor 402, and the q-axis is defined along a direction given by rotating the d-axis counterclockwise by 90 degrees (i.e., the direction perpendicular to the d-axis). An angle that the α-axis and the d-axis make is defined as θ, and a rotation phase of the rotor 402 is expressed in terms of the angle θ. In vector control, a rotary coordinate system with the rotation phase θ of the rotor 402 serving as a reference factor is used. In vector control, specifically, a q-axis component (torque current component) and a d-axis component (exciting current component) are used. Both components are current components of a current vector in the rotary coordinate system, the current vector corresponding to a drive current flowing through a winding, and the q-axis component causes the rotor to generate a torque while the d-axis component affects the intensity of magnetic flux penetrating the winding.

Vector control is a method of controlling the motor by performing phase feedback control by which a torque current component value and an exciting current component value are controlled in such a way as to reduce a deflection between an instructed phase, which represents a target phase of the rotor, and an actual rotation phase. Another type of vector control is a method of controlling the motor by performing speed feedback control by which the torque current component value and the exciting current component value are controlled in such a way as to reduce a deflection between an instructed speed, which represents a target rotating speed of the rotor, and an actual rotating speed.

FIG. 4 is a block diagram showing an example of a configuration of the motor control device 157 that controls the motor 509. The motor control device 157 includes at least one ASIC, and executes functions described below.

As shown in FIG. 4, the motor control device 157 includes a phase controller 502, a current controller 503, a coordinate reverse converter 505, a coordinate converter 511, and a pulse width modulation (PWM) inverter 506 that supplies the drive current to the winding of the motor. These component units make up a circuit that performs vector control. The coordinate converter 511 converts the current vector defined in the stationary coordinate system expressed with the α-axis and the β-axis, the current vector corresponding to the drive current flowing through the winding of the A phase and the winding of the B phase of the motor 509, into a current vector defined in the rotary coordinate system expressed with the q-axis and the d-axis. As a result, the drive current flowing through the windings is expressed in terms of a q-axis component current value (q-axis current) and a d-axis component current value (d-axis current), which are current values in the rotary coordinate system. The q-axis current is equivalent to a torque current that causes the rotor 402 of the motor 509 to generate a torque. The d-axis current is equivalent to an exciting current that affects the intensity of magnetic flux penetrating the winding of the motor 509. The motor control device 157 can control the q-axis current and the d-axis current separately. Thus, by controlling the q-axis current in accordance with a load torque applied to the rotor 402, the motor control device 157 allows the rotor 402 to efficiently generate a torque needed for its rotation. This means that, in vector control, the size of the current vector shown in FIG. 3 changes depending on the size of the load torque applied to the rotor 402.

The motor control device 157 determines the rotation phase θ of the rotor 402 of the motor 509 by a method that will be described later, and performs vector control based on a result of the determination. The CPU 151a generates an instructed phase θ_ref representing a target phase of the rotor 402 of the motor 509, and outputs the instructed phase θ_ref to the motor control device 157. Actually, the CPU 151a outputs a pulse signal to the motor control device 157, and the number of pulses of the pulse signal is equivalent to the instructed phase while the pulse frequency of the same is equivalent to a target rotating speed. The instructed phase θ_ref is generated, for example, based on a target rotating speed of the motor 509.

A subtractor 101 calculates a deflection Δθ between the rotation phase θ of the rotor 402 of the motor 509, the rotation phase θ being output from a phase determiner 513, and the instructed phase θ_ref, and outputs the calculated deflection Δθ.

The phase controller 502 acquires the deflection Δθ at a cycle T (e.g., 200 μs). Based on proportional control (P control), integral control (I control), and differential control (D control), the phase controller 502 generates and outputs a q-axis current instructed value iq_ref and a d-axis current instructed value id_ref in such a way as to reduce the deflection Δθ acquired from the subtractor 101. Specifically, based on P control, I control, and D control, the phase controller 502 generates and outputs the q-axis current instructed value iq_ref and the d-axis current instructed value id_ref in such a way as to reduce the deflection Δθ acquired from the subtractor 101 to zero. P control is a control method by which a value to be controlled is controlled based on a value proportional to a deflection between an instructed value and an estimated value. I control is a control method by which a value to be controlled is controlled based on a value proportional to a time integral of a deflection between an instructed value and an estimated value. D control is a control method by which a value to be controlled is controlled based on a value proportional to a time-dependent change in a deflection between an instructed value and an estimated value. The phase controller 502 according to this embodiment generates the q-axis current instructed value iq_ref and the d-axis current instructed value id_ref, based on PID control. This is, however, not the only case to apply. For example, the phase controller 502 may generate the q-axis current instructed value iq_ref and the d-axis current instructed value id_ref, based on PI control. According to this embodiment, the d-axis current instructed value id_ref, which affects the intensity of magnetic flux penetrating the winding, is set to zero. This is, however, not the only case to apply.

The drive current flowing through the winding of the A phase and the winding of the B phase of the motor 509 is detected by current detectors 507 and 508, after which detected drive current values are converted by an A/D converter 510 from analog values to digital values. The current detectors 507 and 508 detect current, for example, at a cycle (e.g., 25 μs) equal to or shorter than the cycle T at which the phase controller 502 acquires the deflection Δθ.

The drive current values, which are given by converting the analog drive current values into the digital drive current values by the A/D converter 510, are expressed by the following equations, as a current value iα and a current value iβ in the stationary coordinate system, using a phase θe of the current vector shown in FIG. 3. The phase θe of the current vector is defined as an angle that the α-axis and the current vector make. I denotes the size of the current vector.

iα=I*cos θe (1)

iβ=I*sin θe (2)

These current values iα and iβ are input to the coordinate converter 511 and to an induced voltage determiner 512.

The coordinate converter 511 converts the current values iα and iβ in the stationary coordinate system into the q-axis current value iq and the d-axis current value id in the rotary coordinate system, using the following equations.

id=cos θ*iα+sin θ*iβ (3)

iq=sin θ*iα+cos θ*iβ (4)

The coordinate converter 511 outputs the current value iq resulting from the conversion, to a subtractor 102. The coordinate converter 511 outputs the current value id resulting from the conversion, to a subtractor 103.

The subtractor 102 calculates a deflection between the q-axis current instructed value iq_ref and the current value iq and outputs the deflection to the current controller 503.

The subtractor 103 calculates a deflection between the d-axis current instructed value id_ref and the current value id and outputs the deflection to the current controller 503.

Based on PID control, the current controller 503 generates a drive voltage Vq and a drive voltage Vd in such a way as to reduce the incoming deflections respectively. Specifically, the current controller 503 generates the drive voltage Vq and the drive voltage Vd in such a way as to reduce the incoming deflections respectively to zero, and outputs the generated drive voltages Vq and Vd to the coordinate reverse converter 505. The current controller 503 according to this embodiment generates the drive voltages Vq and Vd, based on PID control. This is, however, not the only case to apply. For example, the current controller 503 may generate the drive voltages Vq and Vd, based on PI control.

The coordinate reverse converter 505 reversely coverts the drive voltages Vq and Vd in the rotary coordinate system, the drive voltages Vq and Vd being output from the current controller 503, into drive voltages Vα and Vβ in the stationary coordinate system, using the following equations.

Vα=cos θ*Vd−sin θ*Vq (5)

Vβ=sin θ*Vd+cos θ*Vq (6)

The coordinate reverse converter 505 outputs the drive voltages Vα and Vβ resulting from the reverse conversion, to the induced voltage determiner 512 and to the PWM inverter 506.

The PWM inverter 506 has a full-bridge circuit. The full-bridge circuit is driven by a PWM (pulse width modulation) signal based on the incoming drive voltages Vα and Vβ from the coordinate reverse converter 505. The PWM inverter 506 thus generates drive currents iα and iβ corresponding to the drive voltages Vα and VP, and supplies the drive currents iα and iβ to each winding of each phase of the motor 509 to drive the motor 509. According to this embodiment, the PWM inverter has the full-bridge circuit. The PWM inverter, however, may have a half-bridge circuit in place of the full-bridge circuit.

A method of determining the rotation phase θ will then be described. To determine the rotation phase θ of the rotor 402, an induced voltage Ea and an induced voltage EP are used, the induced voltage Ea and induced voltage EP being induced at the winding of the A phase and the winding of the B phase of the motor 509, respectively, by rotation of the rotor 402. Values for these induced voltages are determined (calculated) by the induced voltage determiner 512. Specifically, the induced voltages Eα and Eβ are determined by the following equations, using the current values iα and iβ, which are sent from the A/D converter 510 to the induced voltage determiner 512, and the drive voltages Vα and VP, which are sent from the coordinate reverse converter 505 to the induced voltage determiner 512.

Eα=Vα−R*iα−L*diα/dt (7)

Eβ=Vβ−R*iβ−L*diβ/dt (8)

In the equations, R denotes winding resistance and L denotes winding inductance. A value for winding resistance R and a value for winding inductance L (hereinafter, “control value”) are values characteristics of the motor A serving as the motor 509 in the image forming apparatus, and are stored in the ROM 151b in advance. Control values characteristics of the motor B are also stored in the ROM 151b in advance. The CPU 151a sets the control values based on the type of the motor attached to the motor control device, that is, sets either the control values characteristic of the motor A or the control values characteristic of the motor B. The control values according to this embodiment include, for example, a gain for determining a current instructed value, such as the q-axis current instructed value iq_ref.

The induced voltages Eα and Eβ determined by the induced voltage determiner 512 are output to the phase determiner 513.

Based on a ratio between the induced voltage Eα and the induced voltage Eβ that are sent from the induced voltage determiner 512, the phase determiner 513 determines the rotation phase θ of the rotor 402 of the motor 509, using the following equation.

θ=tan\hat{ }−1(−Eβ/Eα) (9)

According to this embodiment, the phase determiner 513 determines the rotation phase θ by carrying out a calculation using the equation (9). This is, however, not the only case to apply. For example, the phase determiner 513 may determine the rotation phase θ by referring to a table indicating a relationship between the induced voltages Eα and Eβ and the rotation phase θ corresponding to the induced voltages Eα and EP, the table being stored in the ROM 151b or the like.

The rotation phase θ of the rotor 402 that is obtained in the above manner is input to the subtractor 101, the coordinate reverse converter 505, and the coordinate converter 511.

The motor control device 157 repeats the above control process.

As described above, the motor control device 157 according to this embodiment performs vector control of controlling the current values in the rotary coordinate system in such a way as to reduce the deflection between the instructed phase θ_ref and the rotation phase θ. Performing vector control suppresses the motor's stepping out and an increase in motor noise and power consumption caused by surplus torque.

[Motor's Stepping Out]

As described above, according to this embodiment, the rotation phase θ of the rotor 402 of the motor 509 is determined based on the control values characteristic of the motor. For example, if the control values characteristic of the motor B are set as the control values for determining the rotation phase θ in a case of controlling the motor A, the following problems may arise. Specifically, in the above case, because the control values corresponding to the motor B different in type from the motor A actually attached to the motor control device 157 are set, highly precisely determining the rotation phase θ of the rotor of the motor A may become impossible. Consequently, vector control is carried out based on the rotation phase θ that is different from the actual rotation phase of the rotor. This leads to unstable motor control, raising a possibility of the motor's stepping out.

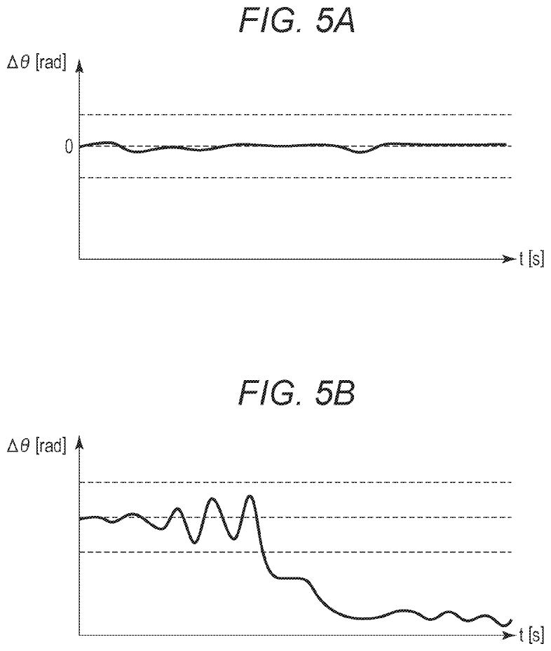

FIGS. 5A and 5B each show an example of the deflection Δθ between the instructed phase θ_ref and the rotation phase θ. FIG. 5A depicts the deflection Δθ in a case where the control values corresponding to the motor to be controlled are set as the control values for determining the rotation phase θ. FIG. 5B depicts the deflection Δθ in a case where control values corresponding to a motor different in type from the motor to be controlled are set as the control values for determining the rotation phase θ.

As shown in FIG. 5A, when the control values corresponding to the motor to be controlled are set as the control values for determining the rotation phase θ, the deflection Δθ during motor control stays within a given range. The given range is set as a range that the deflection Δθ does not exceed, the deflection Δθ fluctuating due to an increase in a load torque applied to the rotor of the motor being running normally, when the control values corresponding to the motor to be controlled are set.

As shown in FIG. 5B, in contrast, when control values corresponding to a motor different in type from the motor to be controlled are set as the control values for determining the rotation phase θ, the deflection Δθ fluctuates heavily to come out of the given range during motor control. This happens for the following reasons. Specifically, for example, when the determined rotation phase θ is advanced relative to the actual rotation phase of the rotor, the motor is given a torque smaller than the load torque applied to the rotor and is rotated by such a smaller torque. As a result, the rotating speed of the rotor drops, which gradually decreases the induced voltage generated at the winding of the motor, leading to lower precision with which the rotation phase θ is determined, that is, leading to variations in the rotation phase θ. As a result, motor control becomes unstable, causing the motor to step out.

Even if vector control is resumed after the motor steps out once, the motor may step out again. To deal with this problem, according to this embodiment, the following configuration is adopted to prevent recurrences of abnormal rotation of the motor.

According to this embodiment, as shown in FIG. 4, the deflection Δθ is input to the CPU 151a. When the deflection Δθ takes a value that is out of the given range, the CPU 151a determines that the rotation of the motor is abnormal, and stores information indicative of the motor rotation being abnormal in the RAM 151c, that is, switches the value of an abnormality flag from “0” to “1”. The CPU 151a then causes the motor control device 157 to perform control for stopping the motor from running. The state of the motor rotating abnormally refers to not only the motor stepping out but also to the rotor being locked by an external force or the like and to the dropping rotating speed.

After switching the value of the abnormality flag from “0” to “1”, that is, after determining that the rotation of the motor is abnormal, the CPU 151a executes a process of identifying a type of a motor attached to the motor control device 157.

[Method of Identifying Type of Motor]

A method of identifying a type of a motor will hereinafter be described.

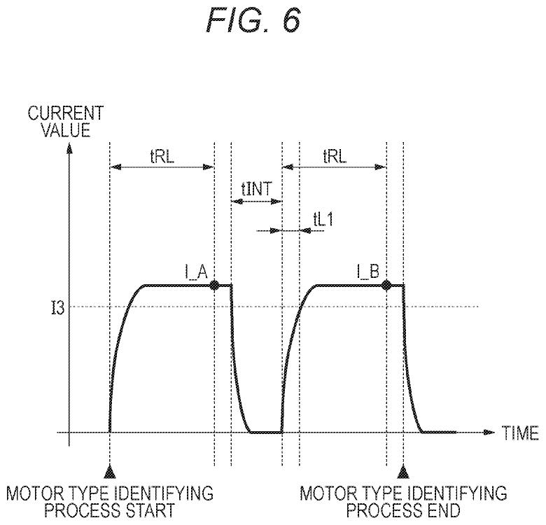

FIG. 6 is a diagram for explaining the method of identifying the type of the motor. Starting the process of identifying the type of the motor, the CPU 151a causes the motor control device 157 to perform control for applying a prescribed voltage E to the winding of the motor 509. Then, after an elapse of a prescribed time tRL, the CPU 151a samples a current I_A flowing through the winding. The prescribed time tRL is determined to be longer than a time that elapses from a point of time at which the prescribed voltage E is applied to the winding to a point of time at which the effect of transient response of a current, which increases due to application of the prescribed voltage E, becomes relatively small to allow a substantially constant current to flow through the winding.

After sampling the current LA, the CPU 151a causes the motor control device 157 to perform control for stopping applying the prescribed voltage E to the winding. Subsequently, after an elapse of a prescribed time tINT, the CPU 151a causes the motor control device 157 to perform control for applying the prescribed voltage E to the winding of the motor 509. The prescribed time tINT is determined to be longer than a time it takes for a current caused by the applied prescribed voltage E and flowing through the winding to reduce to almost zero.

The CPU 151a then measures a time tL1 that elapses from a point of time at which, following the elapse of the prescribed time tINT, the prescribed voltage E is applied to the winding to a point of time at which the current flowing through the winding becomes a prescribed current I3. The CPU 151a samples a current LB after a prescribed time tRL elapses from the point of time at which, following the elapse of the prescribed time tINT, the prescribed voltage E is applied to the winding.

Based on the sampled currents I_A and I_B and the measured time tL1, the CPU 151a estimates the inductance L of the winding. Specifically, the CPU 151a estimates the inductance L of the winding, based on the following equations (10) to (15).

R_A=E/I_A (10)

R_B=E/I_B (11)

R=(R_A+R_B)/2 (12)

L_A=R_A*tL1*K (13)

L_B=R_B*tL1*K (14)

L=(L_A+L_B)/2 (15)

Factor K in the equations is a factor representing a relationship between a resistance value and an inductance value.

When the inductance L is equal to or smaller than a threshold Lth, the CPU 151a determines that the motor attached to the motor control device 157 is the motor A, thus setting the control values used by the motor control device 157, as the control values corresponding to the motor A. When the inductance L is larger than the threshold Lth, on the other hand, the CPU 151a determines that the motor attached to the motor control device 157 is the motor B, thus setting the control values used by the motor control device 157, as the control values corresponding to the motor B.

The above method of identifying the type of the motor is an example of methods this embodiment offers, which are not limited to the above method. For example, the CPU 151a may identify the type of the motor, based on a current value that is detected after an elapse of a prescribed time from the point of application of the prescribed voltage E.

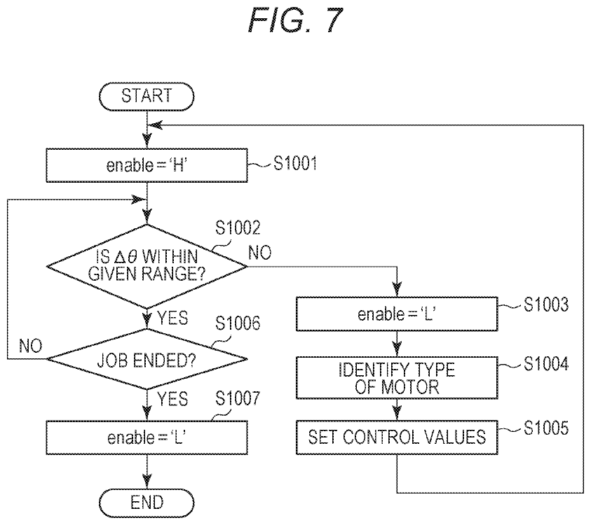

FIG. 7 is a flowchart for explaining a motor control method according to this embodiment. A process flow indicated by this flowchart is executed by the CPU 151a.

At S1001, the CPU 151a outputs an enable signal=‘H’ to the motor control device 157. As a result, the motor control device 157 starts controlling the motor 509.

Subsequently, when the deflection Δθ is not within the given range at S1002, the CPU 151a outputs an enable signal=‘L’ to the motor control device 157 at S1003. As a result, the motor control device 157 stops controlling the motor 509.

Subsequently, at S1004, the CPU 151a identifies the type of the motor.

Then, at S1005, the CPU 151a sets the control values, based on a result of its identifying the type of the motor. Specifically, at S1005, when identifying the motor attached to the motor control device 157 as the motor A, the CPU 151a sets the control values as the control values corresponding to the motor A. When identifying the motor attached to the motor control device 157 as the motor B at S1005, on the other hand, the CPU 151a sets the control values as the control values corresponding to the motor B.

Afterward, the process flow returns to S1001.

When the deflection Δθ is within the given range at S1002, the process flow proceeds to S1006.

At S1006, when a print job of the image forming apparatus is not ended, the process flow returns to S1002.

When the print job of the image forming apparatus is ended at S1006, the CPU 151a outputs the enable signal=‘L’ to the motor control device 157 at S1007. As a result, the motor control device 157 stops controlling the motor 509. As indicated by the above processes, according to this embodiment, when the motor steps out, the CPU 151a stops the motor from running. The CPU 151a then estimates the inductance of the motor attached to the motor control device 157, and, based on the estimated inductance, identifies the type of the motor attached to the motor control device 157. Then, based on a result of its identifying the type of the motor, the CPU 151a sets the control values. As a result, the motor control device 157 is able to perform vector control, using the control values corresponding to the motor attached to the motor control device 157. Hence recurrences of abnormal rotation of the motor are inhibited.

### Second Embodiment

Explanation of the same constituent elements as described in the first embodiment will be omitted in the description of a second embodiment.

In the first embodiment, when the inductance L is equal to or smaller than the threshold Lth, the CPU 151a determines that the motor attached to the motor control device 157 is the motor A. When the inductance L is larger than the threshold Lth, the CPU 151a determines that the motor attached to the motor control device 157 is the motor B. According to the second embodiment, the type of the motor is identified in the following manner.

Specifically, when the estimated resistance R and inductance L satisfy the following equation (16), the CPU 151a determines that the motor attached to the motor control device 157 is the motor A, thus setting the control values used by the motor control device 157, as the control values corresponding to the motor A.

R1≤R≤R2, L1≤L≤L2 (16)

When the estimated resistance R and inductance L satisfy the following equation (17), on the other hand, the CPU 151a determines that the motor attached to the motor control device 157 is the motor B, thus setting the control values used by the motor control device 157, as the control values corresponding to the motor B.

R3≤R≤R4, L3≤L≤L4 (17)

When the estimated resistance R and inductance L do not satisfy none of the equations (16) and (17), the CPU 151a determines that the motor attached to the motor control device 157 is a motor C different from the motor A and from the motor B. The CPU 151a then displays information indicative of the motor C being attached to the motor control device 157, on the display fitted to the operating unit 152, thereby informs the user of wrong motor attachment and prompts the user to replace the motor C.

In this manner, according to this embodiment, when finding by a motor identifying process that the motor C different from the motor A and from the motor B is attached to the motor control device 157, the CPU 151a displays information indicative of the motor C being attached to the motor control device 157, on the display and prompts the user to replace the motor C. This prevents a case where the motor C different from the motor A and from the motor B is run by vector control. In other words, it prevents a case where the motor steps out because vector control is carried out in a condition in which the control values corresponding to the motor attached to the motor control device 157 are different from control values actually set in the motor control device 157.

In the first and second embodiments, by the method depicted in FIG. 6, the resistance value R and inductance value L of the winding of the motor are measured and the type of the motor is identified based on the result of the measurement. This is, however, not the only method to be used. For example, another method may be adopted, by which the motor is provided with a bar code and the motor control device 157 reads the bar code to identify the type of the motor.

### Third Embodiment

Explanation of the same constituent elements as described in the first embodiment will be omitted in the description of a third embodiment.

In the first embodiment, the type of the motor is identified by comparing the detected inductance value with the threshold Lth. The threshold Lth is set based on the inductance value of the motor under a prescribed condition (e.g., under a prescribed temperature T0).

When the motor is run, the temperature of the motor rises. Meanwhile, the inductance value of the motor changes depending on a change in the temperature of the winding. When the type of the motor is identified after the motor steps out, the inductance value may be detected at a temperature different from the prescribed temperature T0, in which case accurately identifying the type of the motor may become impossible. This raises a possibility that control values corresponding to a motor different from the motor attached to the motor control device are set to cause the motor to step out again.

To prevent such a case, according to this embodiment, the following configuration is adopted to inhibit recurrences of abnormal operation of the motor.

<Point of Time at Which Motor Type Identifying Is Started>

As shown in FIG. 2, the CPU 151a has a timer A that measures a time having elapsed from a point of time at which running of the motor 509 by the motor control device 157 is started, and a timer B that measures a time having elapsed from a point of time at which running of the motor 509 by the motor control device 157 is stopped. The point of time at which running of the motor 509 by the motor control device 157 is started is, for example, the point of time at which the CPU 151a outputs the enable signal=‘H’. The point of time at which running of the motor 509 by the motor control device 157 is stopped is, for example, the point of time at which the CPU 151a outputs the enable signal=‘L’. The enable signal is a signal that permits or prohibits an operation by the motor control device 157. When the enable signal is ‘I’, the CPU 151a prohibits an operation by the motor control device 157. In other words, control over the motor 509 by the motor control device 157 is ended by the enable signal ‘L. When the enable signal is ‘H’, the CPU 151a permits an operation by the motor control device 157. The motor control device 157 thus performs control over the motor 509, based on an instruction output from the CPU 151a.

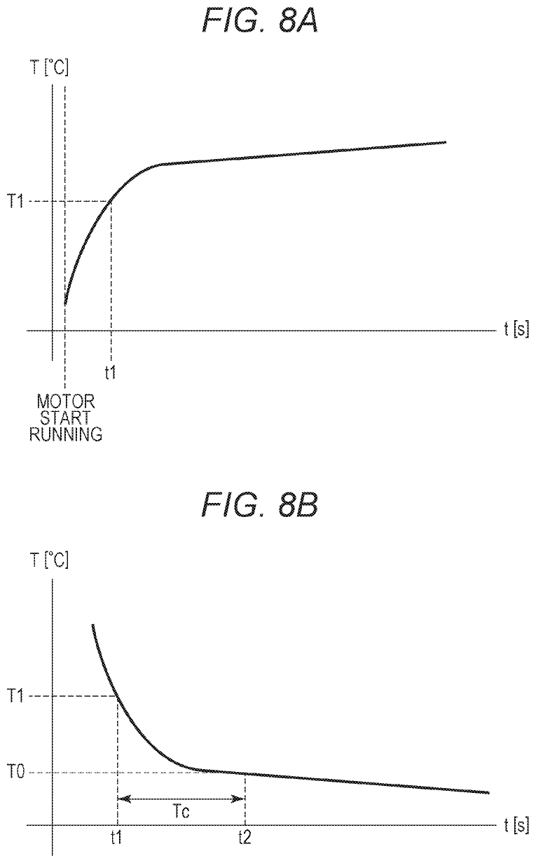

FIGS. 8A and 8B each show an example of a change in the temperature T of the motor. FIG. 8A depicts a change in the temperature of the motor being running, showing a case where a value for the temperature T at time t1 is T1, which the timer A registers as its measurement result when the motor is stopped from running FIG. 8B depicts a change in the temperature of the motor after the motor is stopped. Changes in the temperature T that are shown in FIGS. 8A and 8B are measurements taken in advance by tests, and are stored in the ROM 151b.

When the motor is started to run, the CPU 151a starts time measurement by the timer A. When the motor is stopped from running, the CPU 151a estimates the temperature T of the motor, based on a result of measurement by the timer A at the stoppage of the motor and on data of the temperature T shown in FIG. 8A. Specifically, for example, the CPU 151a determines the value for the motor temperature T to be T1, as shown in FIG. 8A.

After estimating the motor temperature T, the CPU 151a determines a time Tc it takes for the estimated temperature T (temperature T1 according to this embodiment) to become a temperature T0 at which the type of the motor can be identified highly precisely, based on the result of measurement by the timer A at the stoppage of the motor and on data of the temperature T shown in FIG. 8B. After estimating the motor temperature T, the CPU 151a starts time measurement by the timer B.

At a point of time at which time measured by the timer B is the time Tc, the CPU 151a starts identifying the type of the motor.

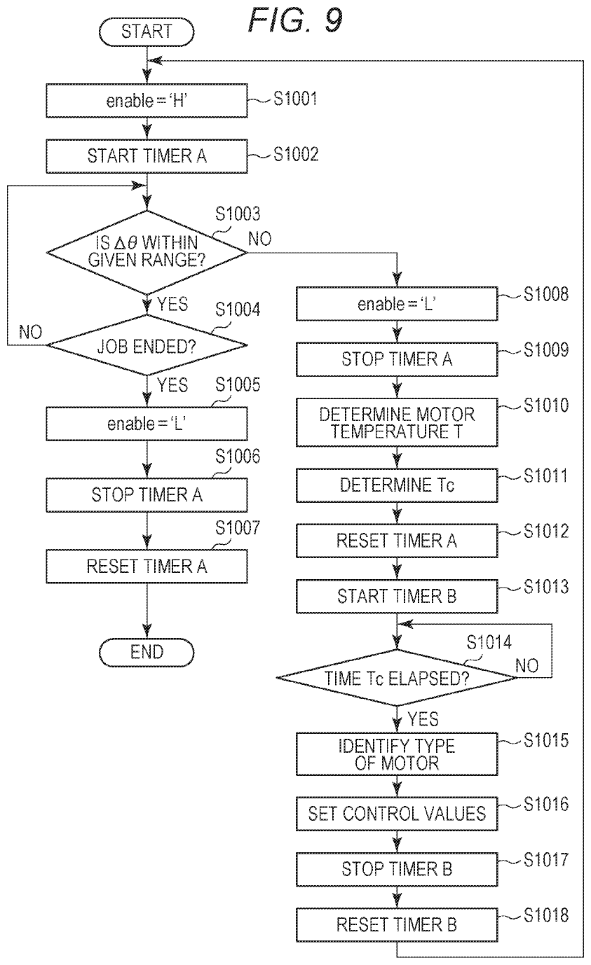

FIG. 9 is a flowchart for explaining a method of identifying the type of the motor 509 attached to the motor control device 157. A process flow indicated by this flowchart is executed by the CPU 151a.

Following the start of a print job, the CPU 151a outputs the enable signal=‘H’ to the motor control device 157 at S1001. As a result, the motor control device 157 starts controlling the motor 509.

Subsequently, the CPU 151a starts the timer A at S1002.

When the deflection Δθ is within the given range At S1003, the CPU 151a proceeds to S1004 along the process flow.

When the print job is not ended at S1004, the process flow returns to S1003.

When the print job is ended at S1004, on the other hand, the CPU 151a outputs the enable signal=‘L’ to the motor control device 157 at S1005. As a result, the motor control device 157 stops controlling the motor 509.

Following this, the CPU 151a stops the timer A at S1006 and resets the timer A at S1007. The CPU 151a then ends the process flow of the flowchart.

When the deflection Δθ takes a value outside the given range at S1003, the CPU 151a outputs the enable signal=‘L’ to the motor control device 157 at S1008. As a result, the motor control device 157 stops controlling the motor 509.

Following this, the CPU 151a stops the timer A at S1009. Then, at S1010, the CPU 151a estimates (determines) the temperature T of the motor, based on a time measured by the timer A and on data of the temperature T stored in the ROM 151b.

Subsequently, at S1011, the CPU 151a determines the time Tc it takes for the estimated temperature T to become the temperature T0, based on a result of measurement by the timer A at the stoppage of the motor and on data of the temperature T stored in the ROM 151b.

The CPU 151a resets the timer A at S1012, and starts time measurement by the timer B at S1013.

When a time measured by the timer B is the time Tc at S1014, the CPU 151a identifies the type of the motor at S1015.

Subsequently, at S1016, the CPU 151a sets control values, based on a result of identifying the type of the motor. Specifically, for example, when identifying the motor attached to the motor control device 157 as the motor A at S1015, the CPU 151a sets the control values as the control values corresponding to the motor A. When identifying the motor attached to the motor control device 157 as the motor B at S1015, on the other hand, the CPU 151a sets the control values as the control values corresponding to the motor B.

Following this, the CPU 151a stops the timer B at S1017, and resets the timer B at S1018. Then, the process flow returns to S1001, at which the print job is resumed.

As indicated by the above processes, according to this embodiment, when the motor steps out, the CPU 151a stops the motor from running. The CPU 151a then estimates the temperature T of the motor, based on a time for which the motor has run, and determines the time Tc it takes for the temperature T to become T0. When the time Tc elapses from a point of time at which the motor is stopped from running, the CPU 151a estimates the inductance of the motor attached to the motor control device 157, and identifies the type of the motor attached to the motor control device 157, based on the inductance. This prevents a case where the type of the motor is identified based on the inductance of the motor in a relatively high-temperature state. This means that the type of the motor attached to the motor control device 157 can be identified highly precisely. Hence recurrences of abnormal rotation of the motor are inhibited.

### Fourth Embodiment

The image forming apparatus 100 according to this embodiment will then be described. In the following description, explanation of the same constituent elements of the image forming apparatus as described in the third embodiment will be omitted.

As described in the first embodiment, when the motor 509 is controlled through vector control, the size of the current value iq is adjusted in accordance with a load torque applied to the rotor 402. This means that, in vector control, the size of the current flowing through the winding changes depending on the size of the load torque applied to the rotor 402. When the motor is running, the larger the current flowing through the winding, the greater an increment of the temperature T of the motor in a prescribed time. Based on this principle, according to this embodiment, the temperature T of the motor is estimated based on the current value iq.

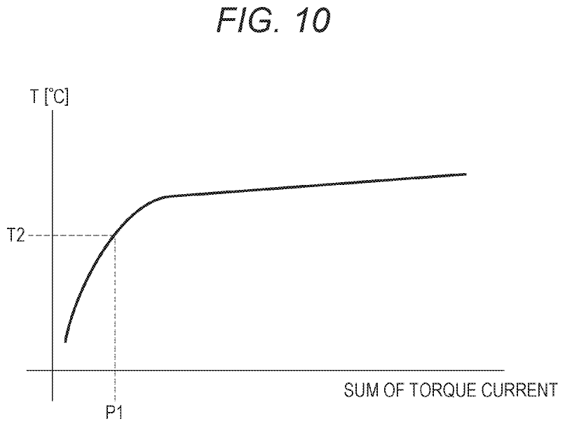

FIG. 10 is a chart showing a relationship between the temperature T of the motor and a sum of the current value iq. As demonstrated in FIG. 10, the temperature T of the motor increases as the sum of the current value iq increases.

When vector control is started, the CPU 151a starts summing up the current value iq. Based on a sum of the current value iq and data of the temperature T shown in FIG. 10, the CPU 151a estimates the temperature T of the motor.

Processes carried out by the CPU 151a following its estimation of the temperature T of the motor are the same as the processes carried out by the CPU 151a according to the third embodiment, and are therefore not described further.

As described above, according to this embodiment, when the motor steps out, the CPU 151a stops the motor from running. The CPU 151a then estimates the temperature T of the motor, based on the sum of the current value iq used during operation of the motor, and determines the time Tc it takes for the temperature T to become T0. When the time Tc elapses from a point of time at which the motor is stopped from running, the CPU 151a estimates the inductance of the motor attached to the motor control device 157, and identifies the type of the motor attached to the motor control device 157, based on the inductance. This prevents the case where the type of the motor is identified based on the inductance of the motor in a relatively high-temperature state. This means that the type of the motor attached to the motor control device 157 can be identified highly precisely. Hence recurrences of abnormal rotation of the motor are inhibited.

### Fifth Embodiment

Explanation of the same constituent elements as described in the first embodiment will be omitted in the description of a fifth embodiment.

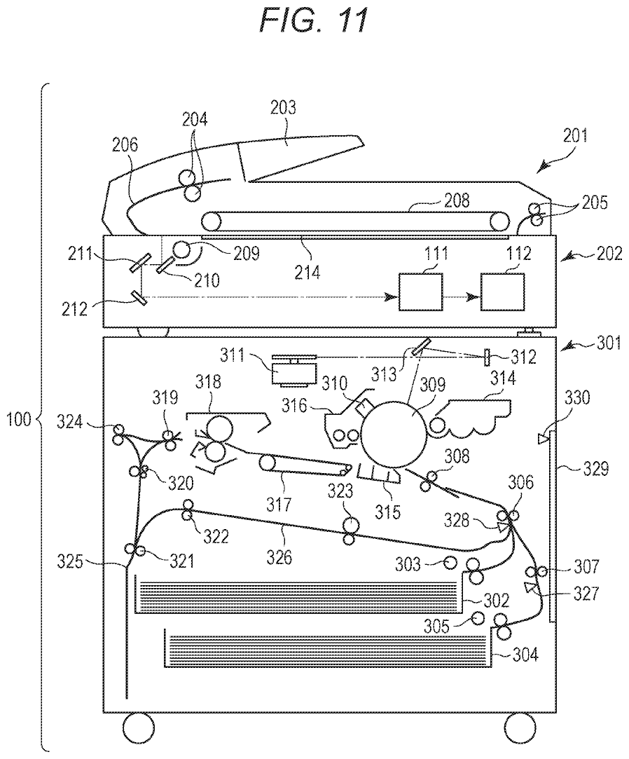

FIG. 11 is a sectional view showing a configuration of the image forming apparatus 100 according to the fifth embodiment. As shown in FIG. 11, the image forming apparatus 100 according to this embodiment includes sheet sensors 327 and 328 that detect the presence/absence of a sheet. The image forming apparatus 100 includes also a door 329 which provides a space for the user to remove a sheet left on a conveyance path. By opening the door 329, the user reaches a sheet left on the conveyance path to get rid of the sheet. The image forming apparatus 100 of this embodiment further includes a door sensor 330 that detects the door 329 opened or closed. The sheet sensors 327 and 328 and the door sensor 330 are connected to the CPU 151a.

According to this embodiment, when a problem with sheet conveyance, such as sheet jamming, has occurred, the CPU 151a executes a process of identifying the type of the motor.

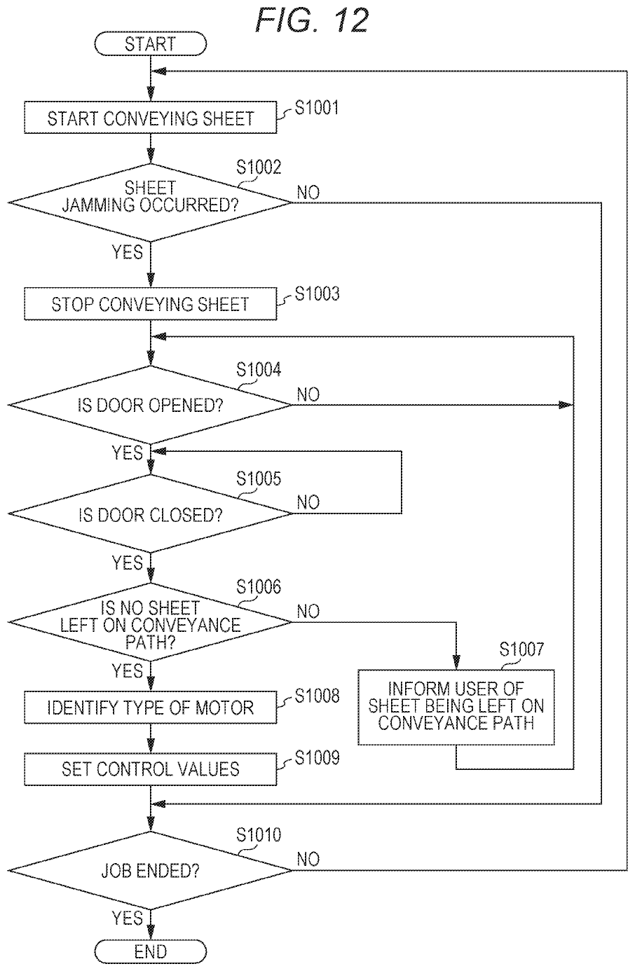

FIG. 12 is a flowchart for explaining a motor control method according to the fifth embodiment. A process flow indicated by this flowchart is executed by the CPU 151a.

At S1001, the CPU 151a starts conveying sheets.

Subsequently, when sheet jamming has occurred at S1002, the CPU 151a stops conveying sheets at S1003. In the following manner, the CPU 151a determines whether sheet jamming has occurred. Specifically, for example, when the sheet sensor 328 does not detect the front end of a sheet after an elapse of a prescribed time from a point of time at which the sheet sensor 327 has detected the front end of the sheet, the CPU 151a determines that sheet jamming (delay jamming) has occurred. In another case, for example, where the sheet sensor 327 remains in a state of detecting a sheet for a second prescribed time, the CPU 151a determines that sheet jamming (delay jamming) has occurred. In this manner, the CPU 151a determines whether sheet jamming has occurred, based on results of detection by the sheet sensors disposed on the conveyance path.

When no sheet jamming has occurred at S1002, the process flow proceeds to S1009.

At S1004, when the door sensor 330 detects the door 329 having been opened, the CPU 151a proceeds to S1005 along the process flow.

Then, at S1005, when the door sensor 330 detects the door 329 having been closed, the CPU 151a proceeds to S1006 along the process flow.

When a sheet is left on the conveyance path, through which sheets are conveyed, at S1006, the CPU 151a causes the operating unit 152 to put information of the sheet being left on the conveyance path on the display to let the user know the sheet being left on the conveyance path at S1007. The process flow then returns to S1005. The sheet being left on the conveyance path is concluded, for example, based on results of detection by the sheet sensors disposed on the conveyance path.

When no sheet is left on the conveyance path, through which sheets are conveyed, at S1006, the process flow proceeds to S1008.

At S1008, the CPU 151a identifies the type of the motor. Specifically, the CPU 151a identifies a type of a motor that drives conveyance rollers corresponding to a location where sheet jamming has been detected. For example, when the sheet sensor 328 detects delay jamming, the CPU 151a identifies the type of the motor that drives the conveyance rollers 307. For example, when the sheet sensor 327 detects stalling jamming, the CPU 151a identifies the type of the motor that drives the conveyance rollers 307.

Subsequently, at S1009, the CPU 151a sets control values, based on a result of identifying the type of the motor. Specifically, for example, when identifying the motor attached to the motor control device 157 as the motor A at S1008, the CPU 151a sets the control values as the control values corresponding to the motor A. When identifying the motor attached to the motor control device 157 as the motor B at S1008, on the other hand, the CPU 151a sets the control values as the control values corresponding to the motor B.

When the print job is not ended at S1010 to follow, the process flow returns to S1001.

When the print job is ended at S1010, on the other hand, the CPU 151a ends the process flow of this flowchart.

In this manner, according to this embodiment, when a problem with sheet conveyance (e.g., sheet jamming) is detected, the CPU 151a executes the process of identifying the type of the motor that drives the conveyance rollers corresponding to the location where the sheet jamming has occurred. Based on the result of identifying the type of the motor, the CPU 151a sets the control values. As a result, the motor control device 157 is able to perform vector control, using the control values corresponding to the motor attached to the motor control device 157. Hence recurrences of abnormal rotation of the motor are inhibited.

The motor type identifying method according to the fifth embodiment can be carried out as the motor type identifying method described in any one of the first to fourth embodiments.

According to the first to fifth embodiments, for example, the image forming apparatus 100 is equipped with the motor A when shipped out from a factory. The control values used in the motor control device 157 are therefore set as the control values corresponding to the motor A.

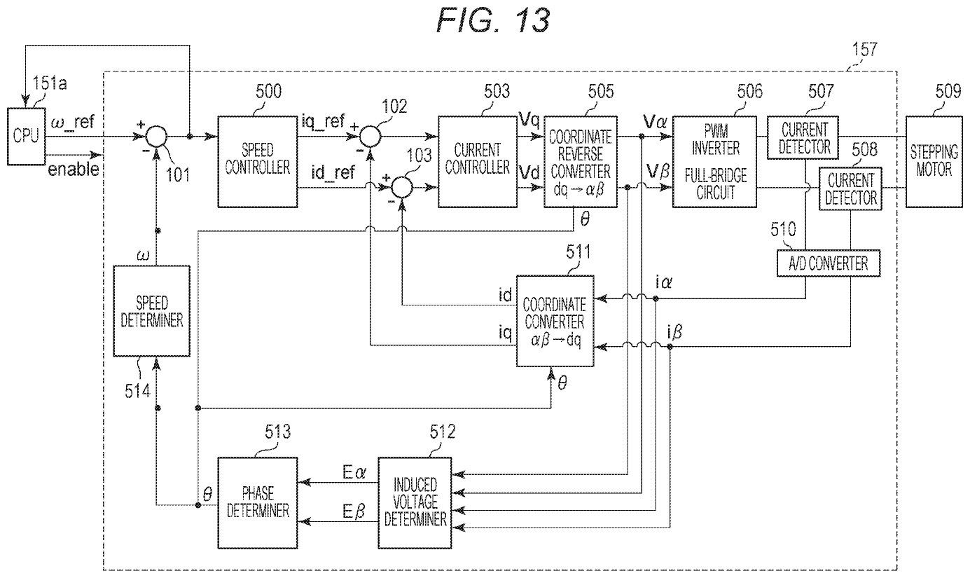

In vector control according to the first to fifth embodiments, the motor is controlled by performing phase feedback control. Vector control, however, is not limited to phase feedback control. For example, vector control may be configured such that the motor is controlled by feeding back a rotating speed ω of the rotor 402. Specifically, as shown in FIG. 13, a speed determiner 514 is incorporated in the motor control device, in which the speed determiner 514 determines the rotating speed ω, based on a time-dependent change in the rotation phase θ output from the phase determiner 513. The rotating speed is determined, using the following equation (18).

ω=dθ/dt (18)

Meanwhile, the CPU 151a outputs an instructed speed ω_ref representing a target rotating speed of the rotor. A speed controller 500 is also incorporated in the motor control device, in which the speed controller 500 generates and outputs the q-axis current instructed value iq_ref and the d-axis current instructed value id_ref in such a way as to reduce a deflection between the rotating speed ω and the instructed speed ω_ref. Vector control may be configured such that the motor is controlled by carrying out such rotating speed feedback control. In this configuration, abnormal rotation of the motor may be detected, for example, based on the deflection Δω between the rotating speed ω and the instructed speed ω_ref. Abnormal rotation of the motor may also be determined based on the current value id.

The first to fifth embodiments are applied not only to motor control performed through vector control. For example, the first to fifth embodiments are applied to any motor control device having a configuration for feeding back a rotation phase and a rotating speed.

In the first to fifth embodiments, a stepping motor is used as the motor that drives a load. This stepping motor, however, may be replaced with a different type of a motor, such as a DC motor. The motor is not limited to a two-phase motor. The above embodiments may be applied also to a motor having different phases, such as a three-phase motor.

In the first to fifth embodiments, a permanent magnet is used as the rotor. The rotor, however, is not limited to a permanent magnet.

According to the present disclosure, recurrences of abnormal rotation of the motor are inhibited.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-195389, filed Oct. 16, 2018, and Japanese Patent Application No. 2019-132262, filed Jul. 17, 2019, which are hereby incorporated by reference herein in their entirety.

What is claimed is:

1. A motor control device comprising:
a detector configured to detect a drive current flowing through a winding of a motor attached to the motor control device;
a first determiner configured to determine a rotation phase of a rotor of the motor attached to the motor control device, using the drive current detected by the detector and a preset control value;
a controller configured to control the drive current flowing through the winding of the motor attached to the motor control device in such a way as to reduce a deflection between the rotation phase determined by the first determiner and an instructed phase representing a target phase of the rotor of the motor;
a first discriminator configured to determine whether rotation of the motor attached to the motor control device is abnormal; and
a second discriminator configured to identify, in a case where the first discriminator determines that the rotation of the motor attached to the motor control device is abnormal, a type of the motor attached to the motor control device,
wherein
in a case where the first discriminator determines that the rotation of the motor attached to the motor control device is abnormal, the controller sets a control value corresponding to the type of the motor identified by the second discriminator, as the control value that the first determiner uses when determining the rotation phase.

2. The motor control device according to claim 1, wherein
the controller controls the drive current, based on a torque current component, in such a way as to reduce the deflection, the torque current component being a current component that is defined in a rotary coordinate system based on the rotation phase determined by the first determiner and that causes the rotor to generate a torque.

3. The motor control device according to claim 1, wherein
in a case where the first discriminator determines that the rotation of the motor attached to the motor control device is abnormal, the controller stops the motor attached to the motor control device from running and then executes an identifying process of identifying the type of the motor attached to the motor control device, and wherein
based on a drive current detected by the detector in the identifying process, the second discriminator identifies the type of the motor attached to the motor control device.

4. A motor control device comprising:
a detector configured to detect a drive current flowing through a winding of a motor attached to the motor control device;
a first determiner configured to determine a rotating speed of a rotor of the motor attached to the motor control device, using the drive current detected by the detector and a preset control value;
a controller that controls the drive current flowing through the winding of the motor attached to the motor control device in such a way as to reduce a deflection between the rotating speed determined by the first determiner and an instructed speed representing a target rotating speed of the rotor of the motor;
a first discriminator configured to determine whether rotation of the motor attached to the motor control device is abnormal;
a second discriminator configured to identify, in a case where the first discriminator determines that the rotation of the motor attached to the motor control device is abnormal, a type of the motor attached to the motor control device;
wherein
in a case where the first discriminator determines that the rotation of the motor attached to the motor control device is abnormal, the controller sets a control value corresponding to the type of the motor identified by the second discriminator, as the control value that the first determiner uses when determining the rotating speed.

5. The motor control device according to claim 4, wherein
the motor control device includes a second determiner that determines a rotation phase of the rotor, and wherein
the controller controls the drive current, based on a torque current component, in such a way as to reduce the deflection, the torque current component being a current component that is defined in a rotary coordinate system based on the rotation phase determined by the second determiner and that causes the rotor to generate a torque.

6. The motor control device according to claim 4, wherein
in a case where the first discriminator determines that the rotation of the motor attached to the motor control device is abnormal, the controller stops the motor attached to the motor control device from running and then executes an identifying process of identifying the type of the motor attached to the motor control device, and wherein
based on a drive current detected by the detector in the identifying process, the second discriminator identifies the type of the motor attached to the motor control device.

7. The motor control device according to claim 6, wherein
the controller starts the identifying process after an elapse of a first time from a point of time at which the motor is stopped from running, and wherein
the first time is determined based on a time that elapses from a point of time at which the motor is started running to the point of time at which the motor is stopped from running.

8. The motor control device according to claim 6, wherein
the controller starts the identifying process after an elapse of a second time from a point of time at which the motor is stopped from running, and wherein
the second time is determined based on the drive current in a period during which the motor is running.

9. A sheet conveyance apparatus comprising:
a conveyance unit configured to convey a sheet;
a motor control device configured to control a motor that drives the conveyance unit; and
a first discriminator configured to determine whether conveyance of the sheet has a problem;
wherein
the motor control device includes:
a detector configured to detect a drive current flowing through a winding of a motor attached to the motor control device;
a first determiner configured to determine a rotation phase of a rotor of the motor attached to the motor control device, using the drive current detected by the detector and a preset control value;
a controller configured to control the drive current flowing through the winding of the motor attached to the motor control device in such a way as to reduce a deflection between the rotation phase determined by the first determiner and an instructed phase representing a target phase of the rotor of the motor;
a second discriminator configured to identify, in a case where the first discriminator determines that conveyance of the sheet has a problem, a type of the motor attached to the motor control device,
wherein
in a case where the first discriminator determines that conveyance of the sheet has a problem, the controller sets a control value corresponding to the type of the motor identified by the second discriminator, as the control value that the first determiner uses when determining the rotation phase.

10. The sheet conveyance apparatus according to claim 9, further comprising a sheet sensor configured to detect presence or absence of the sheet, wherein
in a case where the sheet sensor remains in a state of detecting the sheet for a predetermined time, the first discriminator determines that conveyance of the sheet has a problem.

11. The sheet conveyance apparatus according to claim 9, further comprising:
a first sheet sensor configured to detect presence or absence of the sheet; and
a second sheet sensor disposed downstream relative to the first sheet sensor in a conveyance direction in which the sheet is conveyed, the second sheet sensor detecting presence or absence of the sheet, wherein
in a case where the second sheet sensor still does not detect the sheet after an elapse of a prescribed time from a point of time at which the first sheet sensor has detected the sheet, the first discriminator determines that conveyance of the sheet has a problem.

12. The motor control device according to claim 9, wherein
the controller controls the drive current, based on a torque current component, in such a way as to reduce the deflection, the torque current component being a current component that is defined in a rotary coordinate system based on the rotation phase determined by the first determiner and that causes the rotor to generate a torque.

13. The motor control device according to claim 9, wherein
in a case where the first discriminator determines that conveyance of the sheet has a problem and sheet conveyance is stopped, the controller executes an identifying process of identifying a type of the motor attached to the motor control device, and wherein
based on a drive current detected by the detector in the identifying process, the second discriminator identifies the type of the motor attached to the motor control device.

14. A sheet conveyance apparatus comprising:
a conveyance unit configured to convey a sheet;
a motor control device configured to control a motor that drives the conveyance unit; and
a first discriminator configured to determine whether conveyance of the sheet has a problem,
wherein
the motor control device includes:
a detector configured to detect a drive current flowing through a winding of the motor attached to the motor control device;
a first determiner configured to determine a rotating speed of a rotor of a motor attached to the motor control device, using the drive current detected by the detector and a preset control value;
a controller configured to control the drive current flowing through the winding of the motor attached to the motor control device in such a way as to reduce a deflection between the rotating speed determined by the first determiner and an instructed speed representing a target rotating speed of the rotor of the motor; and
a second discriminator configured to identify, in a case where the first discriminator determines that conveyance of the sheet has a problem, a type of the motor attached to the motor control device,
wherein
in a case where the first discriminator determines that conveyance of the sheet has a problem, the controller sets a control value corresponding to the type of the motor identified by the second discriminator, as the control value that the first determiner uses when determining the rotating speed.

15. The sheet conveyance apparatus according to claim 14, further comprising a sheet sensor configured to detect presence or absence of the sheet, wherein
in a case where the sheet sensor remains in a state of detecting the sheet for a predetermined time, the first discriminator determines that conveyance of the sheet has a problem.

16. The sheet conveyance apparatus according to claim 14, comprising:
a first sheet sensor configured to detect presence or absence of the sheet; and
a second sheet sensor disposed downstream relative to the first sheet sensor in a conveyance direction in which the sheet is conveyed, the second sheet sensor detecting presence or absence of the sheet, wherein
in a case where the second sheet sensor still does not detect the sheet after an elapse of a prescribed time from a point of time at which the first sheet sensor has detected the sheet, the first discriminator determines that conveyance of the sheet has a problem.

17. The motor control device according to claim 14, wherein
the motor control device includes a second determiner that determines a rotation phase of the rotor, and wherein
the controller controls the drive current, based on a torque current component, in such a way as to reduce the deflection, the torque current component being a current component that is defined in a rotary coordinate system based on the rotation phase determined by the first determiner and that causes the rotor to generate a torque.

18. The motor control device according to claim 14, wherein
in a case where the first discriminator determines that conveyance of the sheet has a problem and sheet conveyance is stopped, the controller executes an identifying process of identifying a type of the motor attached to the motor control device, and wherein
based on a drive current detected by the detector in the identifying process, the second discriminator identifies the type of the motor attached to the motor control device.
